(19) United States
(12) Patent Application Publication
(10) Pub. No.: US 2015/0362078 A1
(43) Pub. Date: Dec. 17, 2015

(54) Double-Offset Butterfly Valve

(71) Applicant: Edward G. Holtgraver, Spring, TX (US)

(72) Inventor: Edward G. Holtgraver, Spring, TX (US)

(21) Appl. No.: 14/396,526

(22) PCT Filed: Apr. 25, 2013
(86) PCT No.: PCT/US13/38129

§ 371 Date: Oct. 23, 2014

Related U.S. Application Data
(60) Provisional application No. 61/638,195, filed on Apr. 25, 2012.

(51) Int. Cl. F16K 1/22; F16K 1/226

(52) U.S. Cl. CPC F16K 1/222; F16K 1/2263

(57) ABSTRACT

A double offset butterfly valve comprising a valve body, a valve seat carried by the valve body, and a valve disc mounted on a shaft rotatably journaled in the valve body, the shaft being eccentric both to the centerline of the body and to the centerline of the valve disc (double offset). The periphery of the valve disc has a substantial knife edge which contacts the valve seat without rubbing. As the valve disc rotates, the knife edge remains out of contact with the valve seat until the knife edge contacts the seat at full closure.

### CROSS REFERENCE TO RELATED APPLICATION

This application claims priority to U.S. Application No. 61/638,195 filed on Apr. 25, 2012, the disclosure of which is incorporated herein by reference for all purposes.

### FIELD OF THE INVENTION

The present invention relates to double-offset butterfly valves, and more particularly, to double-offset butterfly valves having improved sealing and greater ease of manufacture.

### BACKGROUND OF THE INVENTION

Butterfly valves, in general, are used to isolate or regulate flow. Butterfly valves can be non-offset or offset. Non-offset valves have the lowest performance ratings and are limited in application. One reason for this is that the valve shaft passes through the disc edge, thereby interrupting the edge continuity. Another is that as the valve opens and closes, some part of the disc is always rubbing against the seat, causing friction and wear.

A single offset butterfly valve has the disc edge offset from the shaft axis so that the shaft does not pass through or interrupt the edge of the disc, however as the disc rotates it is still in constant contact with the seat located in the valve body. This causes wear and deformation of the seat, leading to failure and leakage.

High performance butterfly valves (HPBVs) incorporate two offsets such that the disc edge swings away from the body seat as the valve opens, thereby avoiding rotational interference and preserving the seat integrity. The disc edge designs used by HPBVs allow some rubbing action between the disc edge and the seat. This rubbing occurs as the valve nears the closed position. While this design reduces the overall rubbing and resulting wear, eventually wear will occur to the seat, limiting the valve life.

Triple offset butterfly valves (TOBVs) are well known in the art and are similar to HPBVs except that the profile of the outside periphery of the disc and the body seat are both machined to provide tilted conical surfaces. As known, in TOBVs, the only time the seat and disc are in contact is at full closure. The seat in a TOBV can be made of materials such as metal which need to deform only slightly to conform to the seating surfaces. TOBVs are advantageous in that they seat without rubbing, but the unique conical shape of the disc periphery, which provides the third offset, requires precision machining which can make such valves expensive and difficult to produce.

### SUMMARY OF THE INVENTION

The present invention provides a double offset butterfly valve comprising a valve body, a valve seat carried by the valve body, a valve disc mounted on a shaft rotatably journaled in the valve body, the shaft having an axis eccentric both to the centerline of the body and eccentric to a centerline of the valve disc (double offset). The periphery of the valve disc has a substantial knife edge which contacts the valve seat without rubbing. As the valve disc rotates, the knife edge remains out of contact with the valve seat until the knife edge contacts the seat at full closure. The butterfly valve of the present invention eliminates the rubbing of a HPBV and achieves the sealing capabilities of a TOBV without the costly, precision machining.

The knife edge may be machined integrally to the disc or may be found on a separate ring that is affixed to the disc.

These and further features and advantages of the present invention will become apparent from the following detailed description, wherein reference is made to the figures in the accompanying drawings.

### BRIEF DESCRIPTION OF THE DRAWINGS

FIG. 1 shows an isometric view of one embodiment of the double offset butterfly valve of the present invention.

FIG. 2 is a cross-sectional view taken along the lines 2-2 of FIG. 1.

FIG. 3 is a front elevational view of FIG. 2.

FIG. 4 is an enlarged view of the disc edge knife edge in contact with the valve seat in the double offset butterfly valve of the present invention.

FIG. 5 is an enlarged view of the disc edge knife edge in contact with the valve seat.

FIG. 6 is an enlarged view of the disc edge protrusion before contacting the valve seat.

### DETAILED DESCRIPTION OF PREFERRED EMBODIMENTS

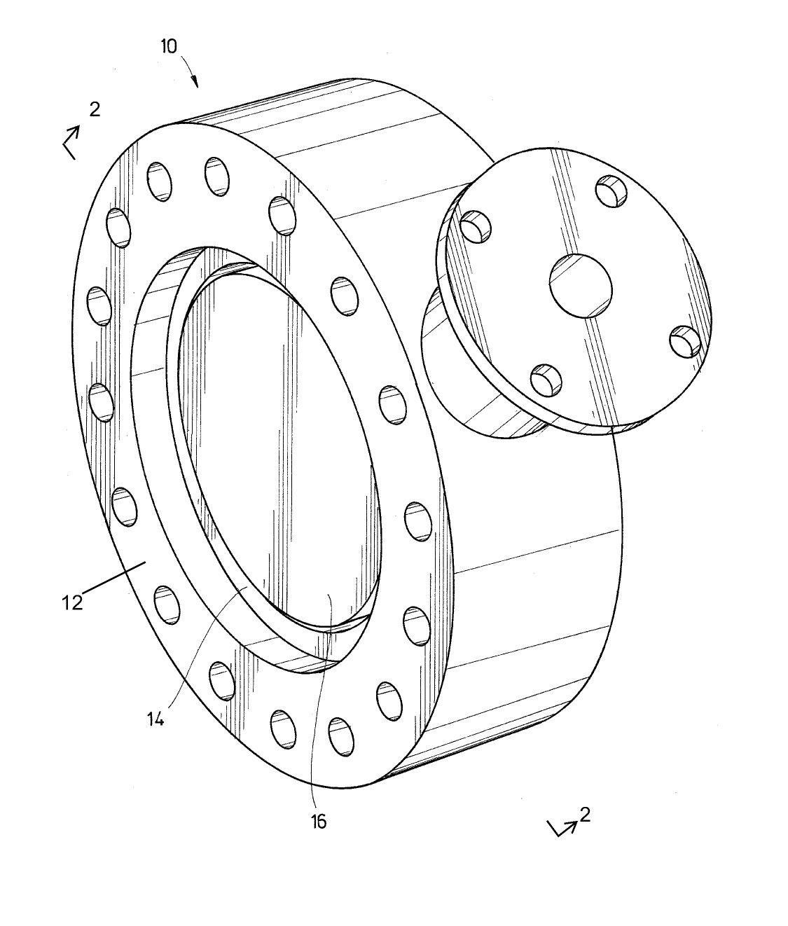

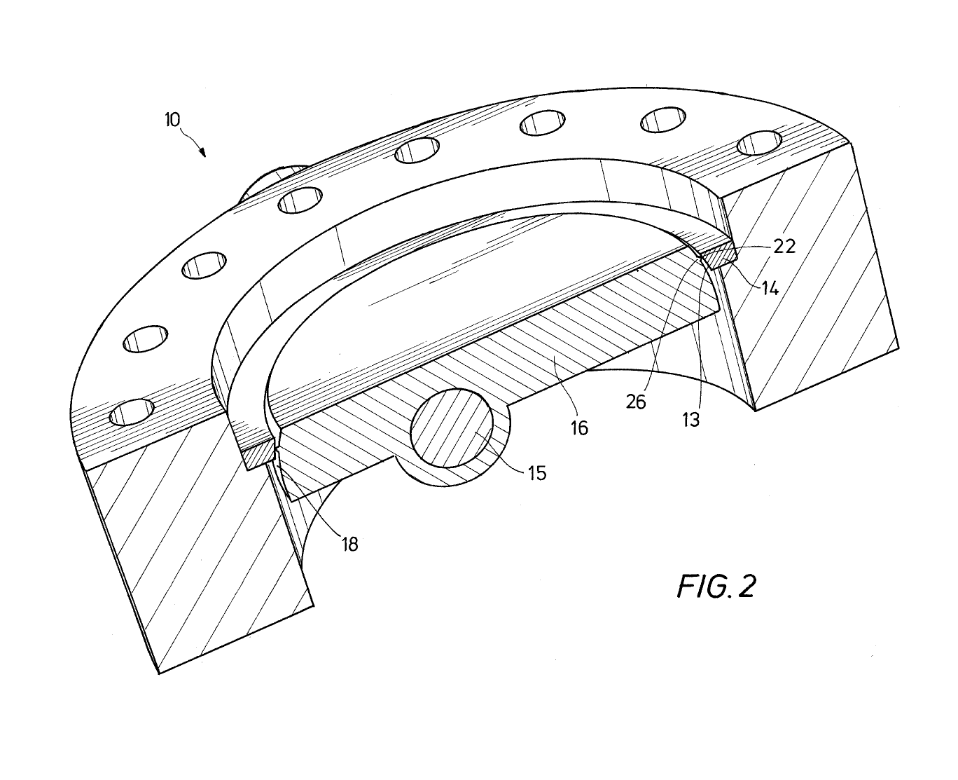

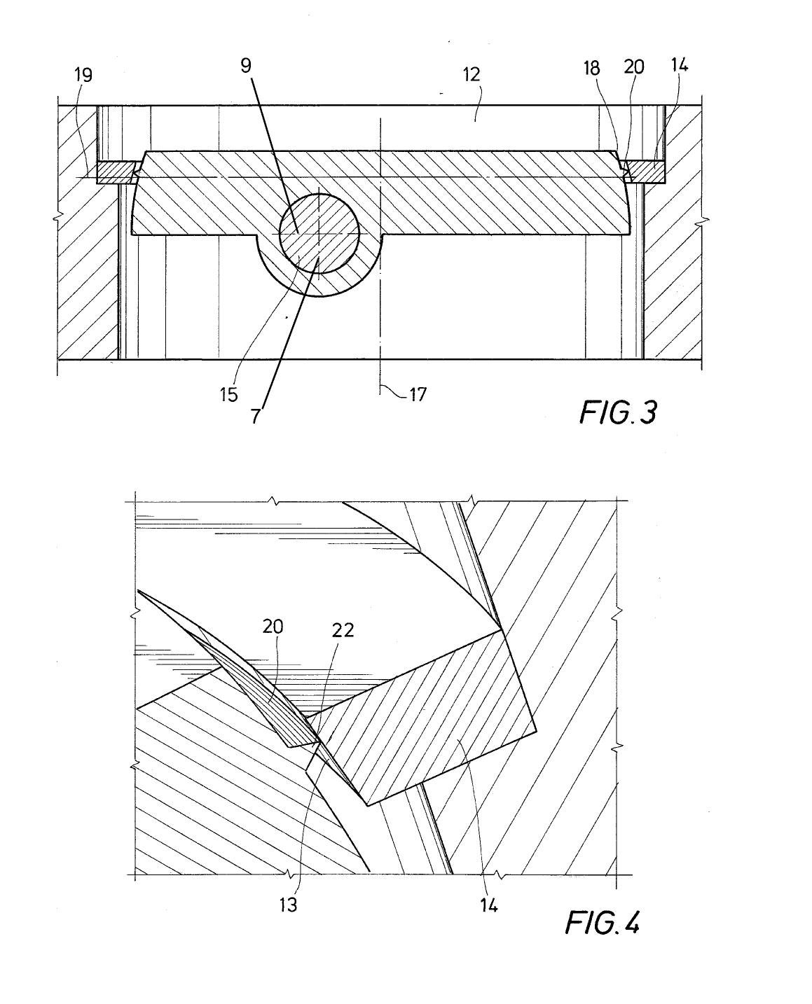

Referring first to FIGS. 1 and 2, there is shown the DOBV of the present invention, shown generally as 10. Butterfly valve 10 comprises a valve body 12, a valve seat 14 carried by valve body 12, and a valve disc 16 mounted on a shaft 15 journaled in valve body 12. As best seen in FIG. 3, shaft 15 is mounted eccentrically in valve body 12 in that the centerline 7 of shaft 15 thereof is eccentric to the centerline 17 of valve body 12 and centerline 9 of shaft 15 is eccentric to centerline 19 of the knife edge 22 (discussed more fully hereafter) of valve disc 16. Valve seat 14 has a radially inwardly facing seating surface 13. In a preferred embodiment, surface 13 is a frustoconical surface which is tangential to the sphere that would be generated by the rotating disc in a single offset butterfly valve design. Valve disc 16 has a peripheral disc surface 18, the disc surface 18 having an annular radially outwardly projecting protrusion 20. Protrusion 20 has a generally triangular transverse cross-section and terminates at its outermost extent in a substantially knife edge 22.

It will be understood that the knife edge of the present invention can vary and still be within the scope of the invention. For instance, the entirety of the valve disc's outer periphery can be shaped to form a knife edge. Additionally, the knife edge may be a ring which is selectively removable from the valve disc.

As torque is applied to shaft 15 to close valve 10, valve disc 16 rotates until knife edge 22 comes into contact with valve seat surface 13. Knife edge 22 is thin enough to deform slightly as greater torque is applied to the shaft. This slight deformation permits the application of higher torque with de minimis wear at the fully closed position and thus achieves a tighter seal without causing any rubbing against the valve seat surface.

Over time, the repeated sealing and unsealing of the valve may cause the knife edge to experience plastic deformation and possibly some permanent deformation. Deformation, if any, of the knife edge 22 will occur at the outermost, sharpest portion of the knife edge 22 and will be the result of the knife edge pressed against the seating surface 13 of the valve seat 14. Thus any deformation will conform to the shape of the seating surface 13 of the valve seat 14, and will not detract from the integrity of the seal.

As used herein, the term “knife edge” or “knife-like edge” is intended to mean a substantially sharp edge capable of deforming slightly when force is applied to the edge while it is in contact with a surface. Thus, it will be understood that a knife edge which is slightly radiused will still be encompassed by the present invention.

As shown in FIG. 3, shaft 15 is eccentric to both the valve body centerline 17 and the centerline 19 of valve disc 16. The two offsets of shaft 15 allow knife edge 22 to engage seating surface 13 only at the fully closed position, i.e., without any rubbing. In the fully closed position, seating surface 13 and edge 22 remain in contact along the entire circumference of valve seat 14.

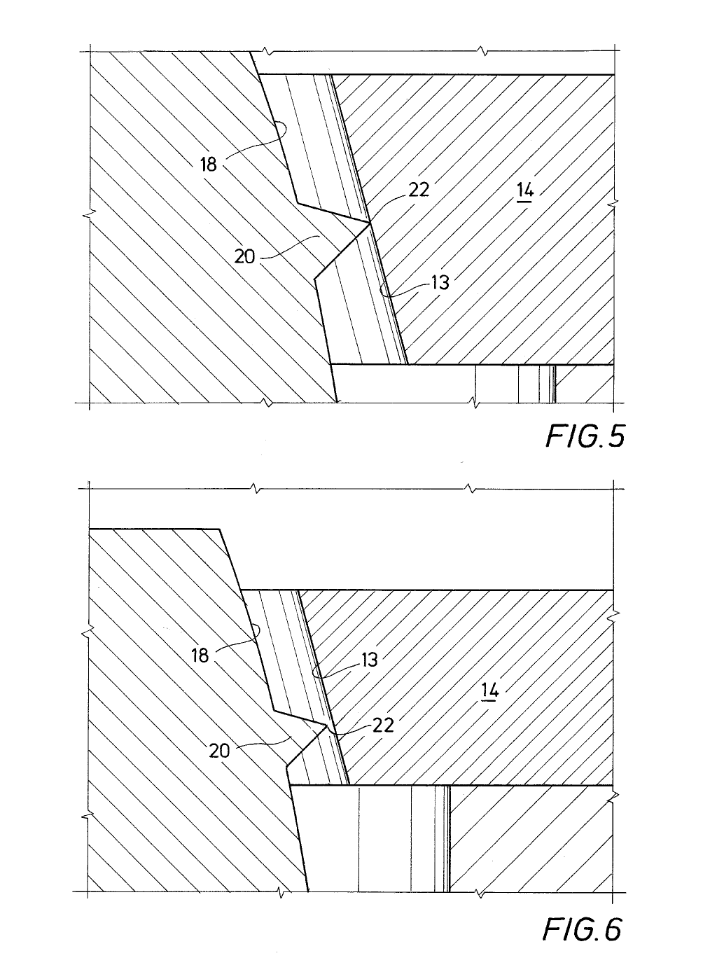

FIGS. 4-5 show an enlarged view of knife edge 22 in contact with valve seat surface 13. Turning now to FIG. 6, it can be seen that knife edge 22 remains out of contact with valve seat surface 13 until substantially the precise moment when it contacts the seat which is also substantially the precise moment of full closure. At the moment of sealing, i.e., full closure, knife edge 22 goes from no contact with valve seat surface 13 to full contact along the entire circumference of valve seat surface 13.

The present invention provides the advantages of a TOBV in that it achieves a tight seal without any rubbing between the disc and the seat. The sharp knife-like edge protrusion of the disc of the valve of the present invention remains out of contact with the valve seat until the valve is fully closed. The sharp disc edge protrusion can be machined onto the disc with a lathe and thus eliminates the need for the difficult and costly machining of a TOBV.

Although specific embodiments of the invention have been described herein in some detail, this has been done solely for the purposes of explaining the various aspects of the invention, and is not intended to limit the scope of the invention as defined in the claims which follow. Those skilled in the art will understand that the embodiment shown and described is exemplary, and various other substitutions, alterations and modifications, including but not limited to those design alternatives specifically discussed herein, may be made in the practice of the invention without departing from its scope.

What is claimed is:

1. A butterfly valve comprising:
a valve body having a flow passage therethrough, said valve body having a valve body centerline running parallel to said flow passage;
a shaft rotatably journaled in said valve body, said shaft having a shaft centerline eccentric to said valve body centerline;
a valve disc secured to said shaft for rotation therewith, said valve disc having a disc centerline eccentric to said shaft centerline;
an annular valve seat disposed in said valve body, said valve seat having a radially inwardly facing seating surface;
said valve disc having a radially outwardly extending knife edge which contacts said seating surface when said valve is in a fully closed position.

2. The valve of claim 1, wherein said knife edge is integral with said valve disc.

3. The valve of claim 1, wherein said knife edge is formed on a selectively removable ring surrounding said valve disc.

4. The valve of claim 1, wherein said knife edge is generally triangular when viewed in transverse cross-section.

5. The valve of claim 1, wherein said seating surface of said valve seat is a frustoconical surface.

6. The valve of claim 1, wherein said valve seat is selectively removable from said valve body.
